(19) United States
(12) Patent Application Publication
(10) Pub. No.: US 2006/0260493 A1
(43) Pub. Date: Nov. 23, 2006

(54) Printing conductive inks

(76) Inventors: Christopher John Travis, Saline, MI (US); Rodney Peter Balmer, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 11/132,661

(22) Filed: May 19, 2005

(51) Int. Cl. B41M 1/04; B41M 1/22

(52) U.S. Cl. 101/491; 101/450.1; 101/401.1

(57) ABSTRACT

A conductive ink containing conductive, metallic particulates is printed onto a substrate by waterless printing on a lithographic press using a relief image plate in a flexographic coating unit or in a lithographic printing unit without fountain solution to provide a layer of conductive print on the substrate. The other units of a sheetfed press may be used to print decorative ink, including full-color printing, further conductive layers, and/or dielectric materials.

### FIELD OF THE INVENTION

The invention relates to printing methods, particularly printing conductive inks to produce electrical circuits and devices.

### BACKGROUND OF THE INVENTION

Printed conductive inks have multiple uses, perhaps one of the most significant being printed electrical circuit and device applications. Electroconductivity is generally provided by conductive particles, flakes, and/or fibers present in the ink in a sufficiently high concentration so that the print is electrically conductive.

Conductive materials in printed electronic circuits are often applied by screen printing. In screen printing, the ink is forced through a mesh screen onto the substrate. A comparatively thick layer (on the order of 25 microns) of a silver-based, conductive material may be applied by screen printing to a substrate. The thicker print obtained with screen printing adds to the cost.

Harrison et al., WO 97/48257, describe lithographically printing electrical circuits. The WO 97/48257 application describes lithographic printing using an electrically conductive ink having a high concentration of metallic silver, 65 to 95% by weight, or a corresponding concentration of a combination of silver with another metallic particle, such as aluminum. The binder may be an alkyd resin, phenolic resin, hydrocarbon resin, turpene resin, or rosin.

Conventional lithographic printing of inks containing conductive metallic particles, however, has been problematic. First, the metallic particles are damaged by contact with the aqueous fountain solution used in lithographic printing, which oxidizes the surfaces of the particles thus reducing the conductivity of the print. Secondly the inks described by Harrison et al. are only poorly emulsified by the fountain solution, which leads to over-emulsification and thin print layers. To attain a sufficient degree of electroconductivity it is often necessary to print the ink in four or more layers. For a traditional lithographic printing press having four units and perhaps a coating unit, then, all of the printing units may be needed to print enough conductive layers, or the substrate may need to be passed though the press a number of times.

### SUMMARY OF THE INVENTION

The present invention provides a method of printing a conductive ink containing conductive particles, particularly silver or other metal particles, on a substrate to form a conductive print. In the method of the invention, the ink is applied by flexographic printing or waterless lithographic printing using a relief plate to provide a layer of conductive print.

In certain embodiments of the invention, the conductive ink is printed using a sheetfed lithographic printing press, with the conductive ink being printed with one of the lithographic printing units by waterless printing or with a flexographic coating unit. The conductive ink is printed using an imaged relief plate. Thus, although the conductive ink may be printed with a lithographic unit, a relief plate is substituted for a lithographic printing plate. The ink is not emulsified in fountain solution or separated on a plate having print areas that are relatively oleophilic that attract ink and nonprint areas that are relatively hydrophilic and attract aqueous fountain solution. Instead, when the conductive ink is printed in one of the lithographic printing units, the aqueous fountain is not used so that the printing is waterless. The waterless printing results in higher electroconductivity in the print than can be obtained by conventional lithographic printing.

In certain embodiments, the conductive ink is printed on a substrate by waterless printing using a printing unit of a sheetfed lithographic printing press, and at least one other unit of the printing press is used to print at least one other ink or layer on the substrate. A colored, non-conductive ink may be printed onto the substrate in one or more further units. A dielectric material may be printed onto the substrate in one or more further units. The conductive ink may also be printed in more than one unit of the printing press.

In certain embodiments, decorative inks, e.g. process colors, are printed onto a substrate using the printing units of a sheetfed lithographic printing press, and the conductive ink is printed onto the substrate using a flexographic coating unit having an imaged relief plate.

The printing method of the invention provides fine definition of print that cannot be achieved in screen printing methods. Further, flexographic printing or waterless lithographic printing do not involve water that can oxidize the surfaces of the conductive metal pieces, which may reduce their conductivity. Thus, waterless printing increases electroconductivity of the print. Further, waterless lithographic printing offers significant advantages over traditional lithographic printing, which has required over-emulsification of the conductive inks to achieve desired printing viscosities, leading to film discontinuities that reduce film or print conductivity. Because a sufficiently conductive print can often be applied in a single pass by the inventive process, the process takes full advantage of the speed and flexibility of lithographic printing presses, so that full-color prints having conductive areas can be produced, and multilayer electrical circuits and devices having one or more conductive layers and one or more dielectric layers can be printed in a single pass through a standard sheetfed press with lithographic and coating units.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value. “Conductive” and “conductivity” are used herein to refer to electroconductive and electroconductivity.

### DETAILED DESCRIPTION OF THE EMBODIMENTS OF THE INVENTION

The following description of the preferred embodiment(s) is merely exemplary in nature and is in no way intended to limit the invention, its application, or uses.

A conductive ink containing conductive particles is printed on a lithographic press without the need for a dampening system on a printing unit or coating unit of a sheetfed press. An imaged relief plate, for example a relief photopolymer printing plate, may be prepared by conventional processes. Flexographic printing plates can be prepared from photopolymerizable compositions by methods such as those described in U.S. Pat. Nos. 4,323,637 and 4,427,759. The photopolymerizable compositions generally comprise an elastomeric binder, at least one monomer and a photoinitiator. Photosensitive elements generally have a photopolymerizable layer interposed between a support and a coversheet or multilayer cover element. Selected areas of the polymerizable layer are exposed to actinic radiation to produce an image of polymerized, insoluble material. Treatment with a suitable solvent removes the unexposed areas of the photopolymerizable layer leaving a printing relief which can be used for flexographic printing.

Computer-to-plate technology allows a thinner plate with excellent control of gain in printing by the dry offset of flexographic method. The surface of the plate should be ink-receptive. A conductive ink composition is printed on a unit fitted with the photopolymer image plate. Unlike a silicone plate that may be used for waterless lithographic printing, a photopolymer plate does not require a paste ink or special cooling of the press to avoid heat-thinning of ink. The ink may be instead formulated with a relatively low viscosity when used with the photopolymer image plate.

In general the image plate should be as thin as possible for easier mounting on a lithographic image roller. One preferred plate has aluminum backing, e.g. about 0.1 mm to about 0.8 mm thick, so that the plate may be thin an yet rigid enough to allow excellent registering of the image area. The thinness of the plate provides a flexible to allow it to be placed on a lithographic press cylinder or used in a flexographic coating unit of a sheetfed lithographic printing press. The thinness of the image plate also allows the plate to be backed with a packing material that may improve ink transfer properties when the image plate is mounted on a lithographic unit cylinder. Packing, e.g. paper or plastic sheet, may be used between the plate and the roller.

The blanket may be rough ground for improved ink coverage and print thickness of the print on the substrate.

The ink comprises conductive particles. The conductive particles preferably consist of or include metal particles, particularly flakes. One preferred conductive particle is silver. The silver may be used in combination with other conductive particles or flakes, including other metal particles and flakes. The preferred silver particles may be included in the ink may be in-amounts from about 60% to about 95% by weight of the ink, preferably from about 65% to about 90% by weight of the ink and most preferably from about 70% to about 80% by weight of the ink. The size of the conductive particles may be in the range from about 0.1 to about 10 microns.

Aluminum particles and particles of other electroconductive metals, e.g. elements falling in group IV of the periodic table, may be used as the conductive particulate. If aluminum or another conductive particulate metal is employed, the percentage of the materials may vary. A metal coated particulate could be very light resulting in a low weight percentage of the conductive particulate in the ink. Other metallic particulates may be included in the ink in amounts from about 15% by weight to about 95% by weight. Suitable materials selected for their characteristic conductivity and chemical stability include silver powder, silver coated particles, titanium oxide, palladium, gold, allotropes of carbon or alloys or mixtures of these. In certain embodiments, the mean metal particle size may be in the range from about 0.1 to about 10 microns, preferably less than about 1 micron.

The ink contains an organic binder in which the metallic particles are suspended. The binder may include one or more binder resins, for example and without limitation, alkyd resin, phenolic resin, hydrocarbon resin, turpene resin and rosin, acrylic resin, and combinations of these. The resin or resins may be in suitable solvents, particularly hydrocarbon solvents, and the ink may include suitable additives used to adjust the printing, conductivity, wear resistance and drying properties of the printed layer. The ink may also include an aqueous binder, for example an aqueous acrylic dispersion.

The ink may be printed on any substrate suitable for a sheetfed lithographic printing press. The substrate should be both flexible and have a degree of affinity towards the printed ink. Examples of suitable substrates include, without limitation, paper such as gloss art paper, bond paper, paperboard, or a semi-synthetic paper or plastic such as polyester or polyethylene sheets. A composite sheet, for example a paper-backed plastic sheet, may also be used.

The inventive printing method provides a conductive print with much finer detail than is possible with other printing methods. The conductive ink may be an energy-curable ink or coldest ink. Fountain solution is not used; thus, the surface of the conductive metal is not oxidized and the ink retains excellent conductivity after printing. A print having high conductivity can be obtained after only one pass (or application layer), avoiding unnecessary cost and complexity of earlier methods of applying multiple print layers.

The printing processes of the invention may be used to manufacture electronic and electrical circuit systems, including electrical interconnects and electrical and electronic components. This type of printing provides the fine definition needed in printing conductive circuits and electronic components without requiring multiple passes that would require carefully registering subsequent passes. Another advantage for printing by this method on a lithographic press is that, because the conductive ink can be printed on a single unit by this method instead of requiring multiple ink applications, the other units of a conventional lithographic press can be used to apply other materials, including dielectric materials printed in desired areas and decorative inks.

In one particular example, the ink may comprise from about 8 to about 16 weight percent of a hydrocarbon resin, from about 2 to about 5 weight percent of an alkyd, from about 10 to about 15 weight percent mineral oil (boiling point range 520-580° F.), and from about 70 to about 80 weight percent silver flake. This ink may be printed using an aluminum-backed, photopolymer imaged relief plate on a waterless lithographic unit of a sheetfed press, using a rough ground blanket, to provide a print thickness of 1.25 microns and a print resistance of about 20 ohm/square. Microscopic examination reveals ink coverage of about 80 percent of the printed area.

The printing processes may be used to print electrical components, including resistors, capacitors, inductors, and RFID tags, as well as electric circuits. Capacitors can be formed by printing one layer of conductive material, overprinting with an insulating ink to form the dielectric layer, then printing a further conductive layer to form the second conducting plate of the capacitor. The lithographic ink used to form the dielectric layer may be a composition which includes a resin such as an alkyd resin, phenolic resin, hydrocarbon resin, turpene resin and rosin, suitable dielectric material in particulate form, for example barium titanate, or other additives used to adjust the dielectric properties of the material, suitable hydrocarbon solvents and other suitable additives used to adjust the dielectric, printing and drying properties of the printed layer.

The lithographic printing process may be used to print microwave stripline structures directly onto flexible substrates to form microwave integrated circuits (MICs), and microwave antennas. Stripline patterns can be printed directly onto flexible substrates which can then be mounted onto planar surfaces to form the stripline elements of microwave integrated circuits (MICs), or planar antenna structures, or to contoured surfaces to form 3-dimensional antenna structures. A printed microwave antenna includes a dielectric substrate with a stripline structure having electrical properties printed on the surface of the substrate. The electrically conductive ink provides electrical conductivity through the antenna. This method of the invention permits the antenna to be fabricated in a simple and inexpensive manner. The antenna is printed with a composition that includes particles of conductive metal, such as silver powder, silver flake, palladium particulate, platinum powder, that may be combined with carbon black and other suitable conductive materials. The ink includes a binder such as a resin mixed with the conductive material. The ink formulation when printed, yields an acceptably low sheet resistivity for many microwave circuit applications.

The printing units and coating unit of the press that are not used to print the conductive ink may be used to print at least one other ink or layer on the substrate. The other units may print a colored, non-conductive ink, a dielectric material, a different conductive ink, or the same conductive in the same or different areas of the substrate. In certain embodiments, decorative inks, e.g. process colors, are printed onto a substrate using the printing units of a sheetfed lithographic printing press, and the conductive ink is printed onto the substrate using a flexographic coating unit having an imaged relief plate. In other embodiments, one or more layers of conductive inks and, optionally, one or more dielectric materials may be applied to the substrate to provide an electrical circuit or device on the substrate.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of printing a conductive ink onto a substrate, comprising:
printing the conductive ink on a lithographic press using a relief image plate in at least one of a flexographic coating unit and a lithographic printing unit without fountain solution to provide a layer of conductive print on the substrate.

2. A method of printing according to claim 1, wherein the conductive ink comprises conductive metal particles.

3. A method according to claim 1, wherein the conductive ink comprises silver flakes.

4. A method according to claim 1, wherein said lithographic press is a sheetfed lithographic press.

5. A method according to claim 1, wherein the conductive ink is printed using an imaged photopolymer plate or relief plate.

6. A method according to claim 1, wherein the flexographic coating unit or the lithographic printing unit comprises a rough ground blanket.

7. A method according to claim 1, wherein the relief image plate has a thickness of from about 0.1 mm to about 0.8 mm.

8. A method according to claim 1, wherein the relief image plate is mounted on an image cylinder with a resilient backing material therebetween.

9. A method of preparing a substrate having a conductive layer of print, comprising:
printing a conductive ink on a substrate on a sheetfed lithographic printing press using a relief image plate in at least one of a flexographic coating unit and a lithographic printing unit,
printing at least one other material on the substrate with unit of the printing press.

10. A method according to claim 9, wherein the at least one other material is a colored, non-conductive ink.

11. A method according to claim 5, wherein the at least one other material is a dielectric material.

12. A method according to claim 9, wherein four lithographic units of the lithographic printing press print process color and the conductive ink is printed in a flexographic coating unit.

13. A method according to claim 9, wherein a conductive circuit is printed.

14. A method according to claim 9, wherein an electric device having at least one conductive layer and at least one layer of a dielectric material is printed.

15. A method according to claim 9, wherein the conductive ink is printed in the flexographic coating unit and at least one lithographic printing unit,

16. A method according to claim 9, wherein a dielectric material is printed using a further unit of the printing press.

17. An article printed according to the method of claim 9.

18. A printed circuit printed according to the method of claim 9.

19. An RFID tag printed according to the method of claim 9.

20. A full-color print having one or more conductive areas printed according to the method of claim 12.

21. A method of printing, comprising printing with an imaged relief plate on a lithographic printing unit.

22. A method according to claim 21, wherein the image relief plate is mounted on an image roller of the printing unit with a resilient material therebetween.

23. A method according to claim 22, wherein the resilient material is paper.
